(19) United States
(12) Patent Application Publication
(10) Pub. No.: US 2010/0115153 A1
(43) Pub. Date: May 6, 2010

(54) ADAPTIVE MULTI-CHANNEL CONTROLLER AND METHOD FOR STORAGE DEVICE

(75) Inventors: Feng-Hsiang Lo, Hsinchu County (TW); Kuo-Hsin Lai, Taichung County (TW); Fu-Chiang Jan, Miaoli County (TW); Chia-Hang Ho, Taipei City (TW); Hsin-Jung Chen, Yilan County (TW); Chin-Yuan Wang, Tainan City (TW); Po-Chang Chen, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/389,356

(22) Filed: Feb. 19, 2009

(30) Foreign Application Priority Data
Nov. 5, 2008 (TW) 97142748

(51) Int. Cl. G06F 13/28

(52) U.S. Cl. 710/22

(57) ABSTRACT

An adaptive multi-channel controller and its method for a storage device are provided for data transmission between a host and the storage device. The storage device is configured to have multiple channels. A channel use amount is determined based on a data access amount of the host. Then, activated channels are selected among the channels according to the channel use amount. The data transmission is then carried out through the selected channels.

### CROSS-REFERENCE TO RELATED APPLICATION

This application claims the priority benefit of Taiwan application serial no. 97142748, filed on Nov. 5, 2008. The entirety of the above-mentioned patent application is hereby incorporated by reference herein and made a part of specification.

### BACKGROUND OF THE INVENTION

1. Field of the Invention

The present invention relates to a storage device and a data accessing method for the storage device. More particularly, the present invention relates to an adaptive multi-channel controller and a method thereof for a storage device.

2. Description of Related Art

A system architecture of a solid state drive (SSD) is an external storage device of a computer, configured based on a permanent storage device, such as a flash memory, non-permanent storage device, or synchronous dynamic random access memory (SDRAM). Due to the permanent or non-permanent storage device, the SSD is an electronic structure, which can substitute a rotating discoid mechanical structure of the conventional hard disk. Compared to the conventional hard disk, the SSD has advantages of fast read/write speed, anti-vibration, low power consumption and no noise, etc.

Since the SSD is used as the data storage device to provide a storage space for a computer host, the computer host can store data to be read or written to in the SSD. Most of the SSDs in the market use flash memories as a storage medium, and an internal storage unit structure thereof is as that shown in FIG. 1. A minimum accessing unit is defined as a page, and the storage space is, for example, divided into a 2048 bytes data space and a 64 bytes spare space. In the future, the data space and the spare space can probably more. However, a minimum data unit of the computer host is defined as a logic block addressing (LBA), and the data amount is 512 bytes. Sizes of data accessing units of the computer host and the SSD are different. Therefore, when the computer host assesses one or five LBAs, it is not in accord with a page unit of the SSD. Since sizes of the data amount and sizes of the storage space of the computer host and the SSD are not matched, waste of the storage space is inevitable, and a usage density of the computer host is rather low, which is one of the problems for data accessing between the computer host and the SSD.

Moreover, as shown in FIG. 1, in present flash memory architecture, each of the flash memories has two device areas 10, each of the device areas 10 has 8192 blocks 12, and each of the blocks 12 has 128 pages. In addition, the flash memory has a characteristic of an interleave mechanism. The interleave mechanism refers to a method for accelerating the data accessing speed, by which pages of two different blocks can be simultaneously accessed. In this way, the pages of the second block can be pre-accessed without waiting a complete access of the pages of the first block, so as to shorten a waiting time. As shown in FIG. 2, R/ B̅ represents a ready/busy signal line in an ordinary operation in which a low level represents a busy state, and R/ B̅ (#1) and R/ B̅ (#2) represent ready/busy signal lines during an interleaving operation. Therefore, when the system is switched to the interleave mechanism, the original time for the R/ B̅ signal is provided to the R/ B̅ (#1) and R/ B̅ (#2), so that two data accessing operations can be completed within the original time, and therefore the accessing speed can be increased.

Moreover, U.S. Pat. No. 7,359,244 provides a method for increasing the accessing speed by utilizing the characteristic of the flash memory. According to the patent, the SSD storage system with eight flash memories determines whether the flash memory is ready or busy. If the flash memory is determined to be busy, the first the flash memory automatically access data from internal pages of this flash memory. Now, there is a busy waiting time for completing the accessing operation, so that the accessing operation of the second flash memory can be simultaneously performed. Therefore, an n-th flash memory can be pre-accessed while a (n-1)-th flash memory is busy, so as to accelerate the accessing speed of the flash memory. Therefore, the accessing speed can be increased by properly using the busy states of the flash memories.

Moreover, another common method is to use a SSD structure configured with a plurality of flash memories, and simultaneously access all of the flash memories, for example, a combination of eight flash memories. In this manner, data amount that is eight times that of a single flash memory for the same time interval, so that an overall data accessing bandwidth for reading and writing is expanded. However, a serious problem is occurred due to the inconsistence of the unit data amounts of the host and the flash memory. When the host accesses the SSD with eight flash memories, the data bandwidth is expanded by eight times, and the unit data amount can be 2048 B×8=16384 B, namely, a 16K data bandwidth is provided for accessing. However, the host has to access 32 LBAs each time for accessing all of the flash memories. Taking a worst case as an example, when the host accesses only one LBA, which is only 512 B, so that the whole flash memory storage space is only utilized for 512 B/16384 B, which is about 3.125%. Therefore, 96.875% of the storage space is wasted. Therefore, for the SSD with a plurality of the flash memories, though the data bandwidth can be increased by integer times, and can achieve a fast data accessing speed. However, for the inconsistence of the unit data amounts of the host and the flash memory, if the host only read a small amount of data, the storage space of the flash memory is wasted.

However, the conventional technique still does not disclose a method that can avoid wasting the storage space of the flash memory, and can perform an adaptive access operation to the flash memory according to the LBA data amount of the host.

### SUMMARY OF THE INVENTION

Accordingly, the present invention provides an apparatus and a method that can resolve a problem of wasting a storage space due to inconsistence of unit data amounts between a host and a flash memory, and meanwhile data accessing speed is accelerated based on an interleave mechanism of the flash memory.

The present invention provides an adaptive multi-channel control method for a storage device, for performing a data transmission between a host and the storage device. The storage device is configured to provide data accessing paths having multiple channels. The adaptive multi-channel control method comprises following steps. A channel use amount of the storage device is determined according to a data access amount of the host. A plurality of activated channels corresponding to the channel use amount is selected from the channels. The data transmission between the host and the storage device is then carried out through the selected channels.

Moreover, the present invention provides an adaptive multi-channel storage device, for performing a data transmission between a host and the adaptive multi-channel storage device. The adaptive multi-channel storage device at least comprises an adaptive multi-channel controller and a memory module. The memory module is coupled to the adaptive multi-channel controller through a plurality of channels. The adaptive multi-channel storage device determines a channel use amount of the adaptive multi-channel storage device according to a data access amount of the host. A plurality of activated channels corresponding to the channel use amount is selected from the channels, so as to perform the data transmission between the host and the adaptive multi-channel storage device through the selected activated channels.

In order to make the aforementioned and other objects, features and advantages of the present invention comprehensible, few exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a structure of a general flash memory.

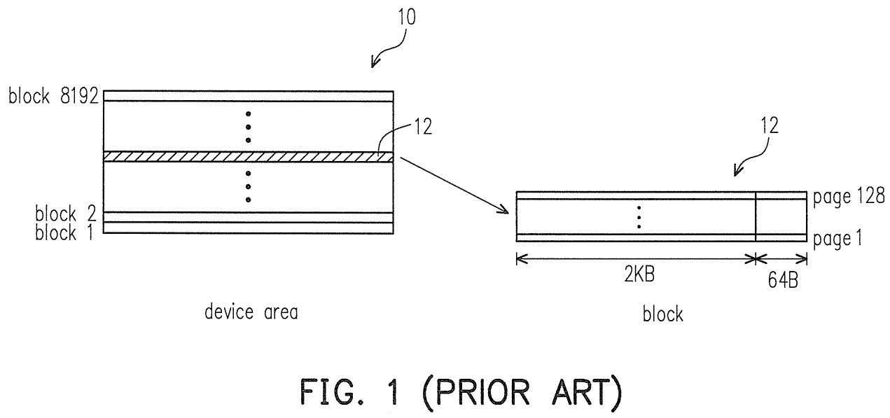

FIG. 2 is a timing schematic diagram illustrating an interleave mechanism of page data of different blocks of a flash memory.

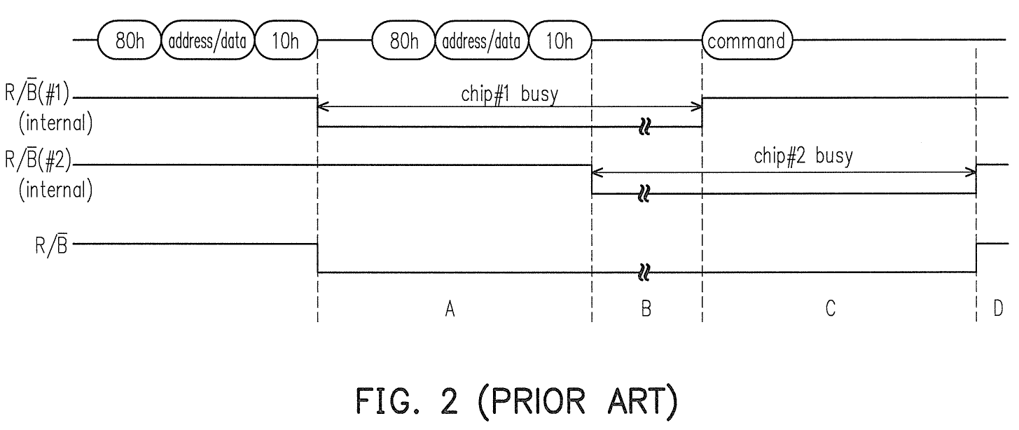

FIG. 3 is a schematic diagram illustrating a system structure with a host and an SSD according to an embodiment of the present invention, by which are illustrated.

FIG. 4 is a schematic diagram illustrating a multi-channel/multi-bank memory structure.

FIG. 5 is a flowchart illustrating an adaptive multi-channel control method.

FIG. 6 is a schematic diagram illustrating an internal structure of an AMCC and connections between the AMCC and multiple channels of a memory.

### DESCRIPTION OF EMBODIMENTS

The present invention provides an adaptive multi-channel controller and its method for a data storage device. In the following description, a solid state drive (SSD) is taken as an example. The method and the device of the present invention can all be applied to any storage device that can be configured to a multi-channel structure and has an interleave mechanism.

Generally, a data storage application system mainly comprises two parts, i.e., a computer host and a SSD. A host controller device is formed by the computer host, which can transmit data to be assessed to the SSD for storage. The data storage device is formed by the SSD, which is used for storing data to be accessed. In an adaptive multi-channel/multi-bank flash memory SSD system structure, the multi-channel can provide different data bandwidths, so that a maximum data bandwidth is different according to different channel amounts defined by a user. In addition, the multi-bank utilizes the interleave mechanism of the flash memory, and the required amount of the flash memories is varied as the bank amount defined by the user varies. Therefore, the amounts of the channel and the bank can be defined according to actual requirements of the user.

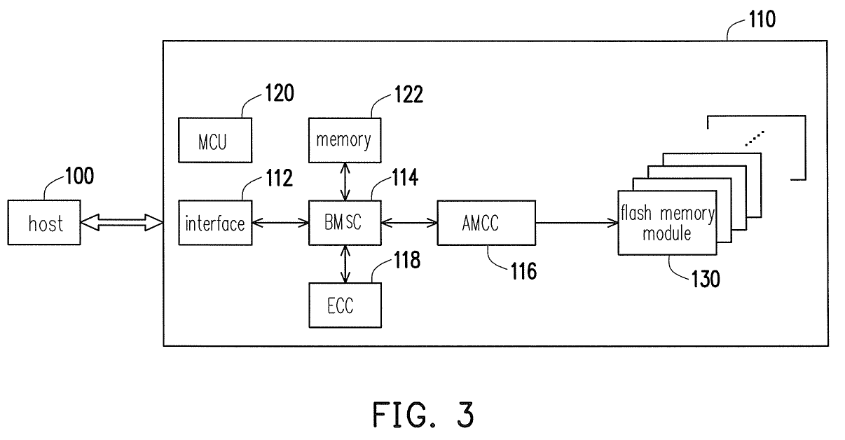

FIG. 3 is a schematic diagram illustrating a system structure according to an exemplary embodiment, in which a host and an SSD are illustrated. The SSD 110 at least comprises an interface 112, a buffer management SRAM/SDRAM controller (BMSC) 114, an error correcting code (ECC) processing unit 118, an adaptive multi-channel controller (AMCC) 116, a microprocessor 120, a memory 122 and a flash memory module 130. Those with ordinary skill in the art can modify other suitable elements therein without changing a structure and a function of the present embodiment.

The interface 112 is mainly used for data transmission with the host 100, which can be any interface such as an IDE, a SATA, a USB, etc. As long as such function is achieved, the specification and type of the interface are not particularly limited. In the present embodiment, the IDE interface is taken as an example.

The microprocessor 120 can be used for controlling the whole SSD, for example an 8051 IC chip. The microprocessor 120 can control each functional modules within the SSD device 110, such as the memory 122, the interface 112, the ECC processing unit 118, the BMSC 114 and the AMCC 116, etc., and a detail connection can be designed according to actual requirements, which is not specifically illustrated therein. The memory 122 is used for temporarily storing data, for example, storing data transmitted from the host 100 to the flash memory module 130, or storing data read from the flash memory module to the host 100, etc. In the present embodiment, the memory 122 is, for example, a synchronous dynamic random access memory (SDRAM), or other types of memories (such as SRAM). The BMSC 114 is used for processing the data temporarily stored in the peripheral module and the memory 122.

Moreover, the ECC processing unit 118 is used for performing an ECC processing to the accessed data. When there is an error in data, the ECC processing unit 118 can correct the error. The AMCC 116 is a core element of the embodiment. The channel use amount can be changed based on a data access amount of the host 100 for accessing the flash memory module 130. The flash memory module 130 is used as a data storage space. Operations of the above circuit are described as follows in detail accompanied with operation modes.

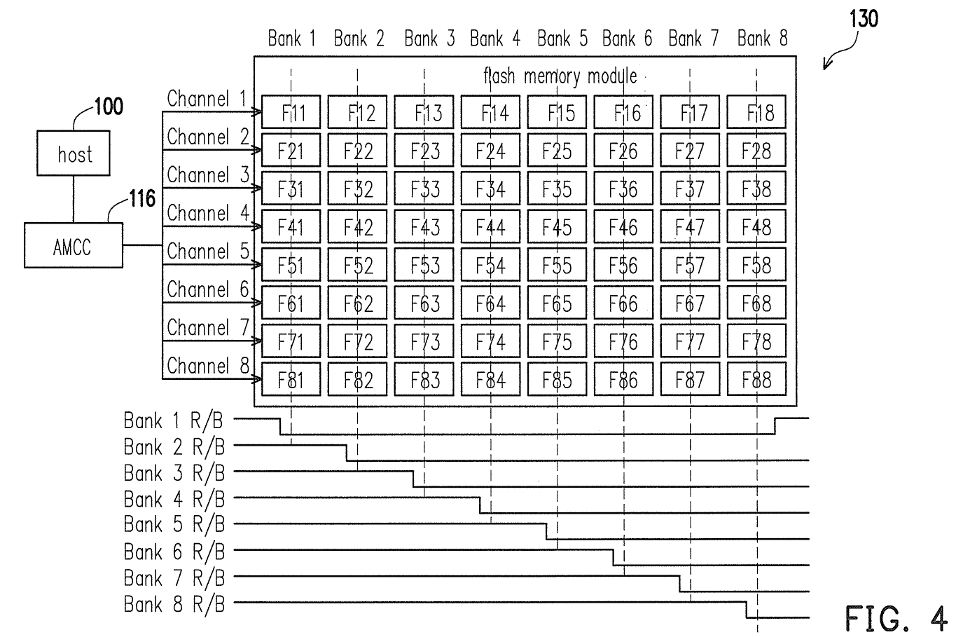

FIG. 4 is a schematic diagram illustrating a multi-channel/multi-bank configuration of a flash memory module. In the embodiment of FIG. 4, the flash memory module 130 comprises eight channels of Channel 1-Channel 8 and eight banks of Bank 1-Bank 8, the flash memory corresponding to each of the channel and the bank is represented by Fij, where i=1 to 8, and j=1 to 8.

As shown in FIG. 3, when the host 100 accesses a data stream, the host data stream first reaches the BMSC 114 and the ECC processing unit 118 via the interface 112 to subject to an ECC encoding/decoding. The data is then temporarily stored in the memory 122, and the AMCC 116 accesses the flash memory module 130. Meanwhile, the microprocessor 120 determines an LBA amount accessed by the host 100 according to the data access amount of the host 100, and provides it to the AMCC 116, so as to determine a corresponding channel use amount. Each four LBAs (total 2048 B) are defined as a section, so as to comply with a minimum storage unit (2048 Byte) of the flash memory. Taking the eight channels of FIG. 4 as an example, a relation between the LBA amount and the channel use amount (Channel 1 to Channel 8) is shown as following equations (1).

Channel=1, 1≦LBA≦4

Channel=2, 5≦LBA≦8

Channel=3, 9≦LBA≦12

Channel=4, 13≦LBA≦16

Channel=5, 17≦LBA≦20

Channel=6, 21≦LBA≦24

Channel=7, 25≦LBA≦28

Channel=8, 29≦LBA (1)

To achieve the adaptive channel amount, the present embodiment provides a design of the AMCC 116, and accompanied with the above relation equations, different channel combinations and arrangements are controlled according to different data access amounts, so as to provide different data bandwidths.

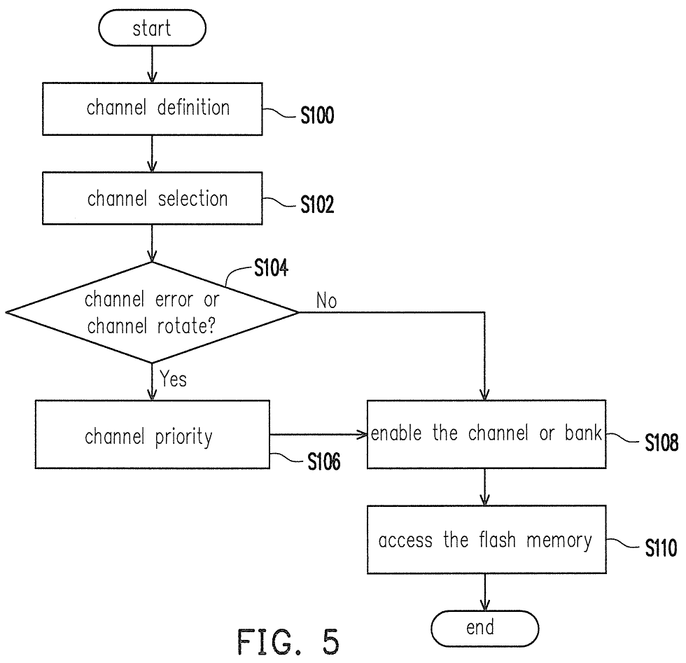

FIG. 5 is a flowchart illustrating an adaptive multi-channel control method. The control flowchart of FIG. 5 is an operation mode of the AMCC 116 of FIG. 3. After the host 100 sends a data access command, the command is finally transmitted to the AMCC 116 of the SSD 110, and the AMCC 116 selects the channels and channel use amount of the flash memory module 130 according to the control flowchart of FIG. 5, so as to access the memory Fij (FIG. 4).

As shown in FIG. 5, the adaptive multi-channel control flow substantially comprises four main steps of channel definition, channel selection, channel mismatch and channel rotate. Next, the four steps are described in detail.

The channel definition refers to a procedure that the AMCC 116 performs the channel definition. In this manner, the AMCC 116 opens certain channels correspondingly for accessing (also referred to as channel use amount in claims) according to the LBA amount accessed by the host 100 and the above equations (1).

As shown in FIG. 5, in step S100, first, the channels in the flash memory module 130 are adaptively opened according to a size of a file transmitted by the host 100, the LBA data amount (data access amount) and the aforementioned relation equations (1). When the host 100 is about to access a large amount of data, more channels can be opened to accelerate the accessing speed.

In the memory structure of FIG. 4, the maximum data bandwidth unit of the 8 channels can reach 16 KB. Conversely, when the host 100 is about to access a small amount of data, relatively less channels are opened, so as to avoid waste of the storage space of other channels. In the present embodiment, the minimum data bandwidth unit is 2 KB, i.e., only one channel is activated. Therefore, each time when the host 100 sends a data access command, the microprocessor 120 controls the AMCC 116 to open a corresponding channel amount according to the LBA data amount of the host 100. A storage unit of each of the channels is 2 KB, and a channel definition (CHDE) selector (signal, referring to FIG. 5) is applied to set the required channel amount. A unit data bandwidth of the selected channel amount is a multiple of 2 KB. For example, a channel amount of four is provided for accessing data, and each unit data bandwidth is 8K.

Next, step S102 is performed, i.e., the so-called channel selection step. In the step S100, the channel amount to be used is first defined, i.e., the suitable channel amount is defined according to the data amount to be accessed by the host 100. In the step S102, those channels that can be selected are selected. In other words, when the channels are not totally opened, the channel selection of the step S102 is executed to select the channels to be opened for accessing.

Namely, after the channels required to be activated are set in the step S100, the system requires knowing which channels should be selected for data accessing under the multi-channel structure. At this time, a channel selector is used to set the channels to be activated according to the selected channel amount. Assuming the AMCC 116 defines the required channel amount to be four via the channel definition selector, the channels to be activated are selected from the eight channels. For example, the channel selector (signal) activates the third, the fifth, the seventh and the eighth channels, the signal lines of the channel selection is operated with the signals of the channel definition (referring to FIG. 5) to correctly enable the flash memories in the selected channels.

Next, in step S104, whether there is a channel error or a channel rotation is judged, and such step is the only optional step. The step S104 is executed when the channel amount in the channel definition of the step S100 is different to the channel amount in the channel selection of the step S102. When the selected channels are beyond the required channels, the AMCC 116 can select the suitable channels according to priorities of the channels. Conversely, when the selected channels are too less, the AMCC 116 mainly determines the channels according to the selected channels.

Moreover, the channel rotation refers to that when a single channel is selected according to the channel definition of the step S100, the storage spaces of the channels are sequentially accessed according to a rotation mechanism, which is further described in the following content.

In the step S104, when there is no channel error or channel rotation, the step S108 is executed, and the selected channels are enabled. In step S110, the data access is performed between the host 100 and the flash memory module 130 via the enabled channels.

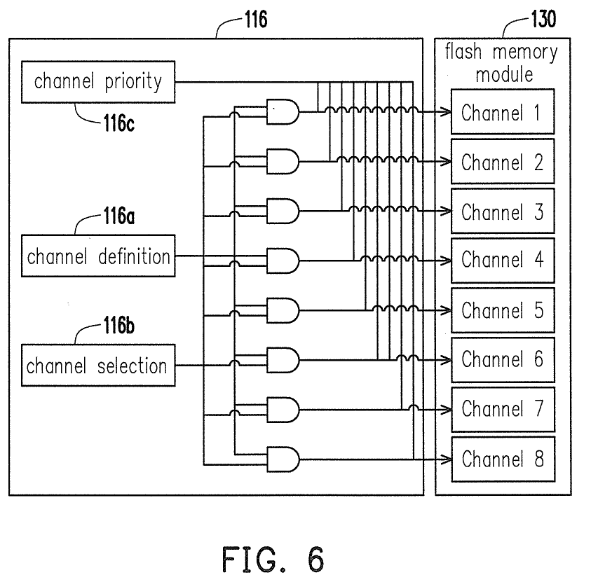

In the above step S104, if the channel error or the channel rotation is occurred, a channel priority processing step of step S106 is executed. Such step is executed when the channel amount in the channel definition of the step S100 is not matched to the channel amount in the channel selection of the step S102, or when a channel rotation is performed. If the channel amount selected by the channel selection is greater than the channel amount defined by the channel definition, the channels are selectively enabled according to the priorities of the channels. Conversely, if the channel amount selected by the channel selection is less than the channel amount defined by the channel definition, the channels selected by the channel selection are activated. Therefore, the present embodiment can provide a mechanism for judging the channel mismatch, and thus the inconsistence of the defined channel amount and the selected channel amount can be prevented. The priority of each of the channels is defined as channel priority (CHPR) definition device (corresponding to 116c of FIG. 6).

Therefore, as described above, the AMCC 116 of the present embodiment can provide the data bandwidth of the channels of the adaptive flash memory module 130 according to the LBA data amount to be accessed by the host 100. When a large amount of data is accessed, a comprehensive channel bandwidth is opened (for example, the channels 1-8 of FIG. 4), so as to accelerate the data accessing speed. Conversely, when a small amount of data is accessed, only a part of the channel bandwidth is opened, so as to avoid waste of the storage spaces of other flash memories. Based on the adaptive channel control mechanism, different channel bandwidths can be switched.

Moreover, for each of the channels, a plurality of the flash memories (i.e., a plurality of banks) can be configured, and the plurality of banks can be formed based on the interleave mechanism of the flash memory, so as to save an access waiting time of each of the flash memories. By such means, the data accessing speed of the whole SSD system structure can be accelerated.

In the aforementioned embodiment, the multi-channel control method is described. Next, the memory structure of FIG. 4 is used for describing an example of the multi-bank. As shown in FIG. 4, the flash memory module 130 is a configured with 8 channels (Channel 1-8), and each of the channels comprises a multi-bank structure (Bank 1-8) formed by a plurality of flash memories. The multi-bank is described below accompanied with an internal schematic diagram of the AMCC 116 of FIG. 6.

First, as shown in FIG. 6, when the host 100 continually accessed a large amount of data, all of the data bandwidth can be opened to improve an accessing density of the host 100 and the accessing speed of the flash memory module 130. The AMCC 116 sets a channel definition selecting signal 116a to select eight channels, so as to open all of the channels Channel 1-8, and open the bandwidth to the maximum. Now, each access can provide the unit data amount of 2048 B×8=16 KB, and each time the host 100 can write 32 LBAs. When the channel definition is set to a full opening, a channel selection predetermined value 116b then activates all of the channels. Now, no value is set to the channel priority signal 116c. Next, the AMCC 116 sequentially transmits the data to be accessed by the host 100 to the flash memories (memories Fi1 (i=1-8) of FIG. 4) in the selected channels. Next, for each of the channels, the flash memories (for example, the memories F1j (i=1-8) of the Channel 1) are connected in serial based on the interleave mechanism of the multi-bank, so as to reduce the access waiting time and increase the data accessing speed.

Next, referring to FIGS. 3-6, a situation that the host only uses a part of the data bandwidth is described. Similarly, the AMCC 116 sets the channel selector 116a as a specific value, for example, to open five channels. Now, the flash memory 130 can provide the unit data amount of 2048 B×5=10240 B. Each time the host 100 can write 20 LBAs, and the channel selector 116b is to open five channels within the eight channels for utilization, for example, the first, the second, fourth, the fifth and the eighth channel, i.e. Channel 1, Channel 2, Channel 4, Channel 5 and Channel 8 are activated. Finally, the AMCC 116 sequentially transmits the data to be accessed by the host 100 to the flash memories of the selected channels, for example, the memories F1j, F2j, F4j, F5j, F8j of FIG. 4, wherein j=1 or j=1-8. For the channels configured with the banks, the interleave mechanism is applied to reduce the access waiting time, so as to increase the data accessing speed.

Moreover, if the channel amount opened by the channel selector 116b is greater than the channel amount set by the channel definition 116a, the priorities of the channels set by the channel priority signal 116c are sequentially judged to open the same amount of channels as that set by the channel definition selector 116a.

A third situation is then described, by which a minimum channel amount, i.e., only one channel is opened. Now, the channel definition selector 116a provides one channel bandwidth, i.e. the unit data amount of 2048×1=2 KB, which is the minimum accessed bandwidth. In this case, each time the host 100 only writes four LBAs. Similarly, the channel selector 116b selects the required channels, for example, the seventh channel Channel 7. In such mode, a rotation mechanism can be added to determine whether or not to sequentially access different channels, so as to avoid accessing a fixed storage space of the flash memory. When the rotation mechanism is required to be activated, the priorities of the channels defined by the channel priority 116c are referenced, and after each channel is sequentially accessed, the channel of a next priority is accessed to continue access the data required by the host 100. Conversely, if the rotation mechanism is not activated, the same channel is fixedly accessed, basically. Therefore, based on the channel setting mechanism of the AMCC 116, different storage spaces of the flash memory can be effectively provided, so as to switch different storage spaces of the channels for the host 100 to perform the data accessing.

In summary, according to the technique provided by the present embodiment, the storage device can adaptively configure suitable channel amount according to an actual data access amount of the host, so as to avoid wasting of the storage space. Moreover, the interleave accessing mechanism of the flash memory can further be used to avoid wasting the waiting time during the accessing, so as to improve the data accessing speed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An adaptive multi-channel control method for a storage device, for performing a data transmission between a host and the storage device, the storage device being configured as a data accessing path having a plurality of channels, and the adaptive multi-channel control method comprising:
determining a channel use amount of the storage device according to a data access amount of the host;
selecting a plurality of activated channels corresponding to the channel use amount from the channels; and
performing the data transmission between the host and the storage device through the selected channels.

2. The adaptive multi-channel control method for a storage device as claimed in claim 1, further comprising:
judging whether the channel use amount is the same as an amount of the activated channels;
performing the data transmission based on the activated channels when the channel use amount is larger than the amount of the activated channels; and
performing the data transmission by using the activated channels according to a priority sequence of the activated channels when the channel use amount is less than the amount of the activated channels.

3. The adaptive multi-channel control method for a storage device as claimed in claim 1, wherein when the channel use amount is one, the method further comprises:
performing the data transmission via a channel rotation.

4. The adaptive multi-channel control method for a storage device as claimed in claim 3, wherein the channel rotation is performed according to the priority sequence of the channels.

5. The adaptive multi-channel control method for a storage device as claimed in claim 1, wherein each of the channels further comprises a plurality of banks formed by a plurality of memories.

6. The adaptive multi-channel control method for a storage device as claimed in claim 5, further comprising:
accessing the banks of each of the channels based on an interleave mechanism when the data transmission is performed through each of the channels.

7. The adaptive multi-channel control method for a storage device as claimed in claim 1, wherein the storage device is a solid state drive (SSD).

8. The adaptive multi-channel control method for a storage device as claimed in claim 7, wherein the memories in each of the channels of the S SD are flash memories.

9. The adaptive multi-channel control method for a storage device as claimed in claim 1, wherein the data access amount of the host is determined with a unit of a logic block addressing (LBA).

10. An adaptive multi-channel storage device, for performing a data transmission between a host and the adaptive multi-channel storage device, and the adaptive multi-channel storage device at least comprising:
an adaptive multi-channel controller; and
a memory module, coupled to the adaptive multi-channel controller through a plurality of channels,
wherein the adaptive multi-channel storage device determines a channel use amount of the adaptive multi-channel storage device according to a data access amount of the host; and
a plurality of activated channels corresponding to the channel use amount is selected from the channels, so as to perform the data transmission between the host and the adaptive multi-channel storage device through the selected activated channels.

11. The adaptive multi-channel storage device as claimed in claim 10, wherein the adaptive multi-channel controller further comprises:
a channel definition device, for generating signals to determine the channel use amount; and
a channel selector, for generating signals to determine the activated channels.

12. The adaptive multi-channel storage device as claimed in claim 11, wherein the adaptive multi-channel controller further comprises:
a channel priority definition device, for defining the priorities of the channels.

13. The adaptive multi-channel storage device as claimed in claim 12, wherein the adaptive multi-channel controller further judges whether the channel use amount is the same to an amount of the activated channels according to output signals of the channel definition device and the channel selector,
wherein when the channel use amount is greater than the amount of the activated channels, the data transmission is performed based on the activated channels; and
when the channel use amount is less than the amount of the activated channels, the data transmission is performed by using the activated channels according to a priority sequence of the activated channels defined by the channel priority definition device.

14. The adaptive multi-channel storage device as claimed in claim 10, wherein the adaptive multi-channel controller performs the data transmission via a channel rotation approach when the channel use amount is one.

15. The adaptive multi-channel storage device as claimed in claim 10, wherein each of the channels further comprises a plurality of banks formed by a plurality of memories.

16. The adaptive multi-channel storage device as claimed in claim 15, wherein the adaptive multi-channel controller accesses the banks of each of the channels based on an interleave mechanism when performing the data transmission through each of the channels.

17. The adaptive multi-channel storage device as claimed in claim 10, wherein the adaptive multi-channel storage device is a SSD.

18. The adaptive multi-channel storage device as claimed in claim 10, wherein the memories in each of the channels of the SSD are flash memories.

19. The adaptive multi-channel storage device as claimed in claim 10, wherein the data access amount of the host is determined with a unit of a LBA.
